(19) United States
(12) Patent Application Publication
(10) Pub. No.: US 2016/0196532 A1
(43) Pub. Date: Jul. 7, 2016

(54) SYSTEM AND METHOD FOR PROJECT STATUS STALENESS, CORRELATION, AND ROLLUP

(71) Applicant: ORACLE INTERNATIONAL CORPORATION, Redwood Shores, CA (US)

(72) Inventors: Niladri DE, Hyderabad (IN); Mani Kumar V R A N KASIBHATLA, Hyderabad (IN); Srinivasu DUDALA, Hyderabad (IN); Surya VEDULA, Hyderabad (IN)

(21) Appl. No.: 14/589,364

(22) Filed: Jan. 5, 2015

(51) Int. Cl. G06Q 10/10; G06Q 10/06

(52) U.S. Cl. CPC G06Q 10/103; G06Q 10/063114; G06Q 10/06393

(57) ABSTRACT

Systems, methods, and other embodiments for providing status staleness of components of a project plan associated with a computer application are described. In one embodiment, a project staleness tool is configured to transform status data into status staleness values for reportable components of a project plan. The status staleness values for the reportable components may be transformed into a status staleness value for the project plan for a particular status type.

### BACKGROUND

A project can be loosely defined as an endeavor to achieve a specific goal, subject to some limiting constraints such as time and resources. Projects occur everywhere and may be of various scopes and importance. Some examples of projects include mapping the human genome, building the golden gate bridge, putting a satellite into orbit, and renovating a kitchen.

Managing a project can be a complicated affair, so much so that “Project Management” has become a small industry by itself. There are books, professional bodies, consultants, and scores of software tools to aid in the process of project management. Useful as all of these may be, delays in projects that can lead to project failure are still alarmingly prevalent.

Accurate decision making is the key to successful project management. Decision making relies heavily on different project statuses. For example, whether to look for new labor resources or not for a project is dependent upon the progress of presently engaged labor resources. If the progress of the presently engaged labor resources is on track, project management will typically assume that everything is alright and, therefore, would not go looking for new resources. However, if project management becomes aware that the progress data has not been updated for fifteen (15) days, for example, then management would likely try to find out what has transpired over those fifteen (15) days.

For example, project management may discover that there is an average delay of fifteen (15) days for all tasks associated with the project. The delay may be due to, for example, resources being stuck at a complex maneuver for which additional expert help is needed but not available. Since no progress was made for the last fifteen (15) days, no update has been reported to the project management system. Clearly, project management has to urgently look for expert help in this situation. The urgency to look for expert help may not have become known to project management if project management had not become aware of the delay.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a project staleness tool;

FIG. 2 illustrates one embodiment of a method performed by the project staleness tool of the computer system of FIG. 1, for determining a status staleness value for a project;

FIG. 3 illustrates one example embodiment of a table listing task progress information associated with a project;

FIG. 4 illustrates one example embodiment of a table listing project total progress associated with the table of FIG. 3;

FIG. 5 illustrates one embodiment of a method performed by the project staleness tool of the computer system of FIG. 1, for determining outliers of a project for a status type;

FIGS. 6A-6C illustrate example embodiments of tables showing status staleness correlation for three example scenarios using the method of FIG. 5; and

FIG. 7 illustrates one example embodiment of a computing device upon which the project staleness tool of the computing system of FIG. 1 may be implemented.

### DETAILED DESCRIPTION

The following terms are used herein with respect to various embodiments.

The terms “project” and “project plan” may be used interchangeably herein.

The term “staleness”, as used herein, refers to how dated or how old information may be. For example, a status staleness value for a project may be ten (10) days, indicating that information related to a particular status type (e.g., labor availability) of the project has not been reported for ten (10) days (e.g., because no update may be necessary if the status is the same as before).

The term “status type”, as used herein, refers to a particular aspect of a project or component of a project that may be reported to provide an update with respect to how well that particular aspect of the project or component of the project is progressing or being utilized. Some examples of status types include project progress, labor availability, raw material availability, equipment availability, failure risk, labor resource usage, resource productivity, public perception of brand value, public perception of a product line, or public perception of the reliability of a product.

The term “reportable component”, as used herein, refers to a component of a project plan for which one or more status types may be reported into a project management system. Some examples of reportable components of a project include tasks of the project, resources used in the project, groups of related tasks of the project, and groups of related resources used in the project.

Systems, methods, and other embodiments for facilitating the determination of how stale or dated project information is for a project plan associated with a computer application are disclosed. Example embodiments are discussed herein with respect to computerized project management, where activities are defined and are to be performed over scheduled time periods using resources. Some activities are related by one or more of timing with respect each other, common category (similar type of activities), or common resources used to complete the activities.

In one embodiment, a project staleness tool is disclosed that is configured to read status data, associated with reportable components of a project, into an input data structure associated with a project management computer application. The status data may be transformed into status staleness values for the reportable components, forming a plurality of status staleness values corresponding to a status type. Each status staleness value indicates how old or dated the status data is for that reportable component (i.e., how long it has been since the status of that reportable component has been updated).

The plurality of status staleness values may be transformed into a staleness value for the project (i.e., a project staleness value), corresponding to the status type. The status staleness value for the project may be output to a data structure associated with the project management computer application for display. The status staleness value for the project is an indication of how old or dated the status data is, in general, for the project.

In one embodiment, data is represented in terms of at least one computer-implemented data structure. A data structure can be transformed within a computing system by transforming the data within the data structure, transforming the structure of the data structure, or both.

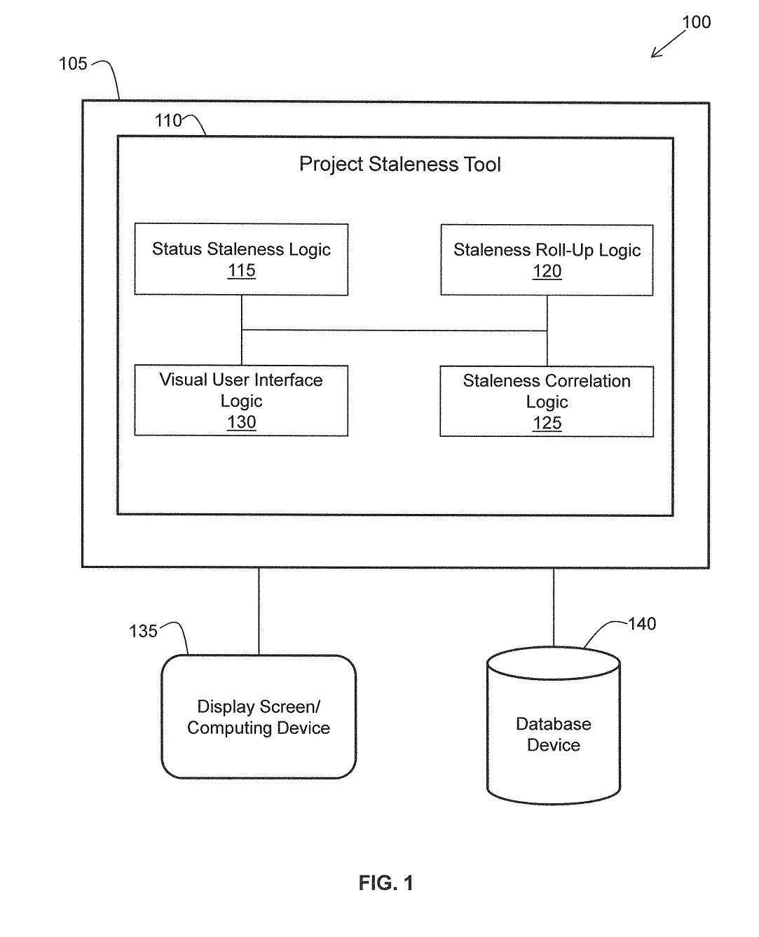

FIG. 1 illustrates one embodiment of a computer system 100, having a computing device 105 configured with a project staleness tool 110. For example, in one embodiment, the project staleness tool 110 may be part of a project management computer application of a company, configured to facilitate the updating of statuses of multiple components of a project plan. In accordance with one embodiment, a graphical user interface is generated by the project management computer application (e.g., by a visual user interface logic of the project staleness tool 110). In one embodiment, the project management computer application may comprise construction management software that computerizes the process for constructing a building or other object. In one embodiment, the software and computing device 105 may be configured to operate with or be implemented as a cloud-based networking system, a software-as-a-service (SaaS) architecture, or other type of computing solution.

With reference to FIG. 1, in one embodiment, the project staleness tool 110 is implemented on the computing device 105 and includes logics for implementing various functional aspects of the project staleness tool 110. In one embodiment, the project staleness tool 110 includes a status staleness logic 115, a staleness roll-up logic 120, a staleness correlation logic 125, and a visual user interface logic 130 which are operably connected to each other within the project staleness tool 110.

However, other embodiments may provide different logics or combinations of logics that provide the same or similar functionality as the project staleness tool 110 of FIG. 1. In one embodiment, the project staleness tool 110 is an executable application including algorithms and/or program modules configured to perform the functions of the logics. The application is stored in a non-transitory medium.

The computer system 100 also includes a display screen 135 operably connected to the computing device 105. In accordance with one embodiment, the display screen 135 is used to display views of and facilitate user interaction with a graphical user interface (GUI) generated by the visual user interface logic 130 for checking project status. In one embodiment, the project staleness tool 110 is a centralized server-side application that is accessed by many users. Thus the display screen 135 may represent multiple computing devices/terminals that allow users to access and receive services from the project staleness tool 110 via networked computer communications.

In one embodiment, the computer system 100 further includes at least one database device 140 operably connected to the computing device 105 or a network interface to access the database device 140 via a network connection. In accordance with one embodiment, the database device 140 is configured to store and manage data structures (e.g., records of project components and associated status data) associated with the project staleness tool 110 in a database system (e.g., a program management computer application).

Referring back to the logics of the project staleness tool 110 of FIG. 1, in one embodiment, the visual user interface logic 130 is configured to generate a graphical user interface (GUI) associated with a project management computer application. For example, the visual user interface logic 130 includes program code that generates and causes the graphical user interface to be displayed based on an implemented graphical design of the interface. In response to user actions and selections via the GUI, associated aspects of components of a project plan may be edited and updated.

In one embodiment, the status staleness logic 115 is configured to generate a status staleness value for each reportable component of a project. The status staleness values are generated based on transforming status data associated with the reportable components which are input (e.g., read) into the status staleness logic 115. The status staleness values for the reportable components may be generated for a particular status type of the project (e.g., raw material availability).

In one embodiment, the visual user interface logic 130 is configured to facilitate reading of status data into at least one input data structure associated with a project management computer application. Furthermore, in one embodiment, the visual user interface logic 130 is configured to operably interact with the staleness roll-up logic 120 to allow a user to drill down from a status staleness value of an organization to a status staleness value of a reportable component of a project.

For example, in one embodiment, a status staleness value for a reportable component of a project may be the number of days since a status of the reportable component was last reported or updated into a project management system. Determination of such status staleness values from status data and manipulation of such status staleness values are discussed more fully herein with respect to the remaining figures.

In one embodiment, the staleness roll-up logic 120 is configured to generate a status staleness value for a project based on multiple status staleness values for the reportable components of the project. The status staleness value for the project corresponds to a particular status type of the project (e.g., raw material availability) as defined by the status type of the multiple status staleness values for the reportable components. In one embodiment, staleness roll-up logic 120 is configured to generate the status staleness value for the project by calculating a weighted average of the multiple status staleness values of the reportable components. In one embodiment, transforming a plurality of status staleness values includes generating a weighted average of the plurality of status staleness values as the project staleness value.

Also, in one embodiment, the staleness roll-up logic 120 is configured to generate a status staleness value for an organization. Just as a staleness value for a project may be generated from multiple staleness values of reportable components of the project, a staleness value for an organization may be generated from multiple staleness values of projects associated with the organization.

For example, the staleness roll-up logic 120 may first generate a status staleness value for each project of an organization based on staleness values for multiple reportable components corresponding to the different projects. The staleness roll-up logic 120 may then generate a staleness value for the organization, for example, by calculating a weighted average of the multiple status staleness values of the multiple projects. Examples of rolling up status staleness values from one level to another are discussed later herein in detail with respect to the remaining figures.

In one embodiment, the staleness correlation logic 125 is configured to determine status staleness outliers of reportable components of a project based on the status staleness values for the reportable components. A status staleness outlier corresponds to a status staleness value, within a group of status staleness values of a group of reportable components, which is significantly different from the other status staleness values in the group.

For example, in one embodiment, the staleness correlation logic 125 is configured to determine status staleness outliers by generating a scatterness value and eccentricity values. The scatterness value is a single value that is generated based on the multiple status staleness values of the reportable components of the project. An eccentricity value is generated for each reportable component of the project based on the multiple status staleness values of the reportable components of the project. In one embodiment, the scatterness value and the eccentricity values are analyzed to determine if any outliers exist among the status staleness values of the reportable components. Generation of scatterness values and eccentricity values is discussed later herein in detail with respect to the remaining figures.

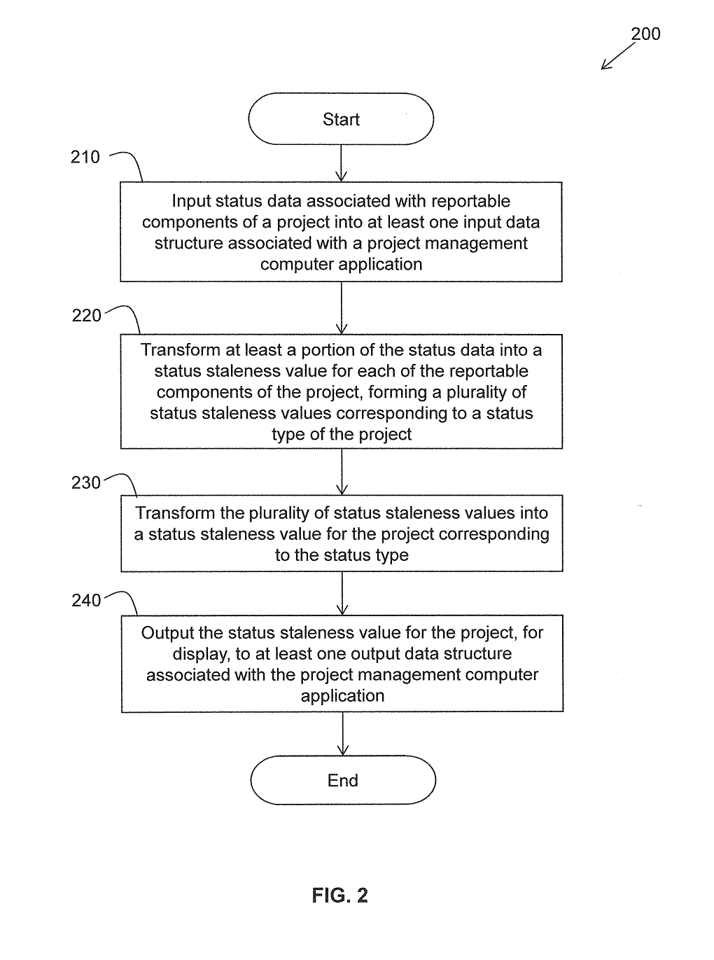

FIG. 2 illustrates one embodiment of a method 200 performed by the project staleness tool 110 of the computer system 100 of FIG. 1, for determining a status staleness value for a project. Method 200 is implemented to be performed by the project staleness tool 110 of FIG. 1, or by a computing device configured with an algorithm of the method 200.

Method 200 will be described from the perspective that a project has many reportable components including tasks and resources. Each reportable component of a project may be reportable in the sense that a status of one or more status types of a component may be reported (e.g., to the system 100). By reviewing the statuses and associated staleness of the components of a project, a user (e.g., a project manager) may gain keen insight into how well the project is doing.

Upon initiating method 200, at block 210, status data associated with reportable components of a project is input into at least one input data structure associated with a project management computer application (e.g., project staleness tool 110 of FIG. 1). In accordance with one embodiment, the status staleness logic 115 of the project staleness tool 110 is configured to read the status data. For example, the status data may correspond to the progress of tasks of the project. The assumption is that status data is normally updated on a regular basis. However, the reporting of status data may be delayed in certain circumstances for certain reportable components. As such, the latest available status data may or may not reflect the true status.

At block 220, at least a portion of the status data is transformed into a status staleness value for each reportable component of the project, forming a plurality of status staleness values. The plurality of status staleness values correspond to a status type of the project (e.g., project progress). In accordance with one embodiment, the status staleness logic 115 transforms the status data into status staleness values. For example, a status staleness value for a reportable component may correspond to a number of days since status data was last reported or updated for the reportable component.

At block 230, the plurality of status staleness values for the components are transformed into a status staleness value for the project, corresponding to the status type. In accordance with one embodiment, the staleness roll-up logic 120 transforms (rolls up) the plurality of status staleness values for the components into the status staleness value for the project. The plurality of status staleness values may be transformed by calculating a weighted average of the status staleness values, in one embodiment. The status staleness value for the project may be representative of an overall average status staleness for the project (e.g., an overall average number of days for which the status type of the project is out of date).

At block 240, the status staleness value for the project is output for display to at least one output data structure associated with the project management computer application. In accordance with one embodiment, the visual user interface logic 130 receives the status staleness value for the project from the staleness roll-up logic 120 and outputs the status staleness value for the project to at least one output data structure. In addition to outputting the status staleness value for the project, an indication of whether the status staleness value for the project is within an acceptable range for the status type may be similarly output for display as well.

In this manner, the project staleness tool 110 will take into account how much time has elapsed since a status of a particular status type of a particular project component has been updated. By similarly accounting for each project component of the project, the project staleness tool 110 is able to make a determination of overall project status staleness for that particular status type. Therefore, a project manager may gain deeper insight into a status of a project and associated project components by realizing how stale (or fresh) is the status data. In accordance with one embodiment, a status staleness value may be determined for multiple status types for a reportable component or a project.

Furthermore, in one embodiment, an organization status staleness value may be generated corresponding to the status type. Such an organization status staleness value may be generated by rolling up the staleness value for the project with at least one other (different) status staleness value for at least one other (different) project associated with the organization. In accordance with one embodiment, the staleness roll-up logic 120 of the project staleness tool 110 performs the rolling up.

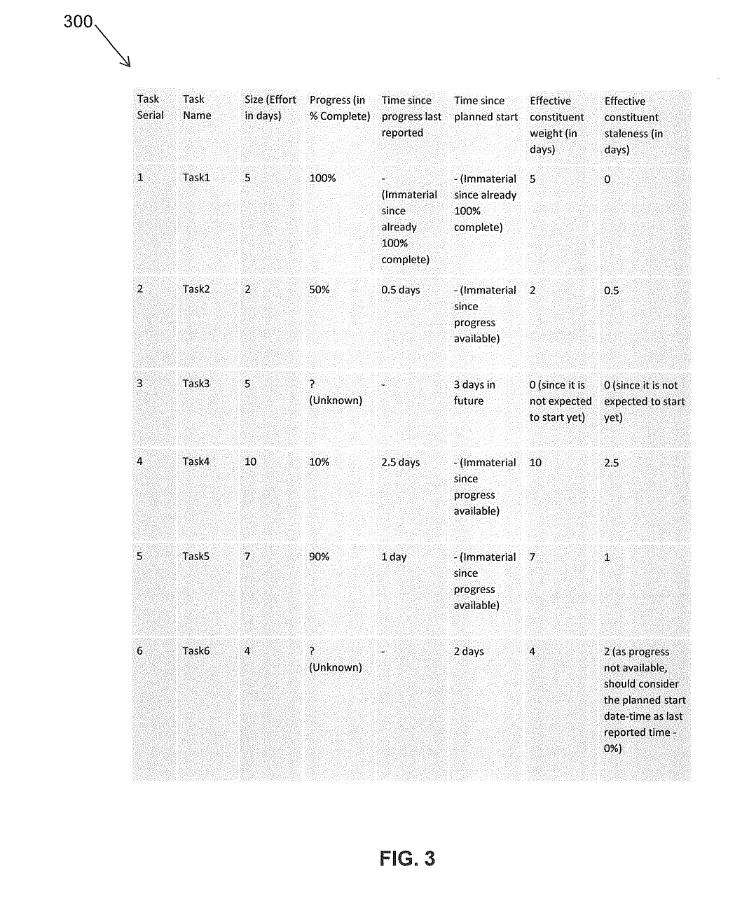

FIG. 3 illustrates one example embodiment of a table 300 listing task progress information (status data) associated with a project. That is, the information in table 300 is associated with a status type known as project progress. In the example of FIG. 3, the reportable components are the six (6) tasks. The status data for each task includes size (effort in days), progress (% complete), time since last reported status last reported, time since planned start, effective constituent (component) weight in days, and effective constituent (component) staleness in days. In one embodiment, a status staleness value may be determined for each task based on the status data. Subsequently, the status staleness values for the tasks may be rolled up to form a status staleness value for the project.

Referring to table 300 of FIG. 3, the status staleness value, ψₛₜₐₜᵤₛ for a task is determined as follows:

ψₛₜₐₜᵤₛ=T_{now}−T_{reported},

where T_{now} is the present date-time, and T_{reported} is when the status was last reported/updated. For example if a project risk was reported 2 days and 3 hours ago, then ψᵣᵢₛₖ=2.125 days.

For a project composed of multiple components such as tasks or resources, the status staleness value of the project is determined as follows:

$${ψ}_{status , project} = \frac{{\sum }_{i = 1}^{n} {ω}_{i} \times ( {T}_{now} - {T}_{i , reported} )}{{\sum }_{i = 1}^{n} {ω}_{i}} ,$$

where ωᵢ is the size (or weight) of the i^{th} component/task, T_{now} is date-time now, T_{i,reported} is when the status for the i^{th} component/task was last reported/updated (in case no reporting is available, T_{i,reported} is assumed to be equal to the planned start date-time), and n is the number of such components/tasks in the project.

For example, referring to table 300 of FIG. 3, a status staleness value for total project progress may be determined based on the task progress information (status data) in table 300. As a result,

$${ψ}_{progress , project} = \frac{5 \times 0 + 2 \times 0.5 + 0 \times 0 + 10 \times 2.5 + 7 \times 1 + 4 \times 2}{5 + 2 + 0 + 10 + 7 + 4} = \frac{41}{28} = 1.464$$

That is, the staleness of total progress for the project is 1.464 days. For this example of project progress status, it is noted here that:

1. If a task is completed in the past, the staleness value of its own progress status is zero.

2. If a task is planned in the future, and no progress is yet available, it does not contribute to the staleness calculation.

3. If no progress update is received for a task, but it is planned to start in the past, then the staleness is calculated by considering the planned start.

4. The actual progress of a task does not contribute to the staleness (but does contribute to the progress).

In this manner, a staleness value for an overall average (total) progress of a project may be determined from the progress staleness values of the constituent components (i.e., tasks) of the project. In accordance with other embodiments, other status types, other than project progress, and other reportable component types, other than tasks, may be used to determine other status staleness values for those other status types.

Furthermore, in accordance with other embodiments, other means may be used to roll-up status staleness values without departing from the scope of the present application. For example, other equations, formulas, or algorithms may be used to determine (roll-up) a staleness value, for the overall average (total) status of a project, by transforming the status staleness values of the constituent components of the project.

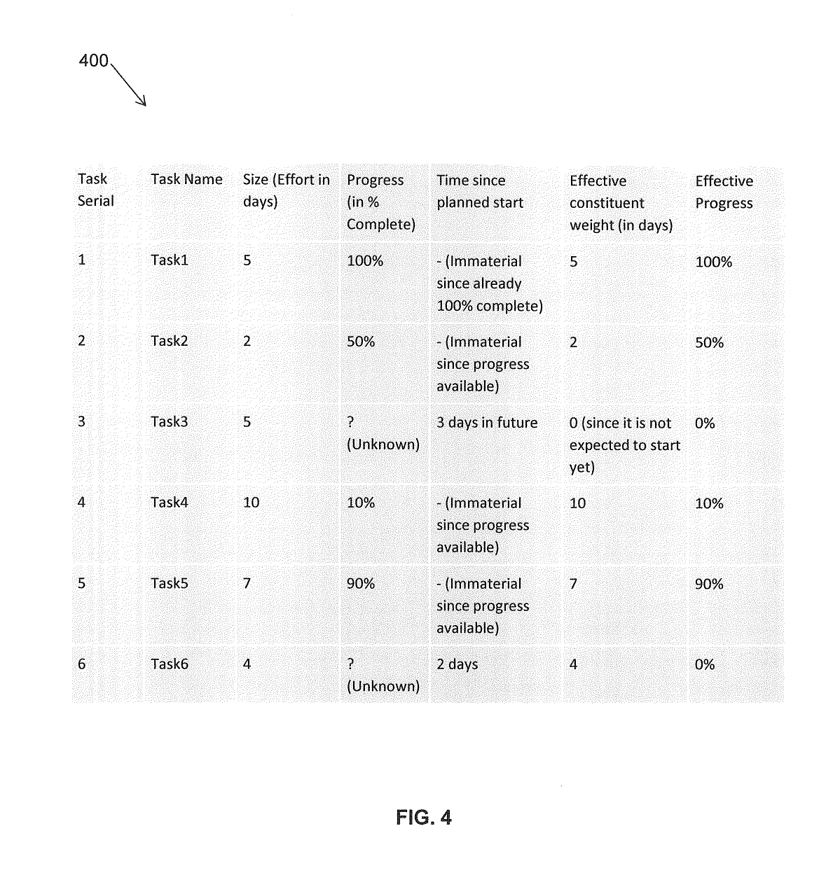

FIG. 4 illustrates one example embodiment of a table 400 listing project total progress associated with the table 300 of FIG. 3. In one embodiment, project total progress may be calculated in a weighted manner, similar to project staleness, as follows:

$${Progress}_{Total} = \frac{5 \times 1 + 2 \times 0.5 + 5 \times 0 + 10 \times 0.1 + 7 \times 0.9 + 4 \times 0}{5 + 2 + 5 + 10 + 7 + 4} = \frac{13.3}{33} = 0.40303 = 40.303 \% .$$

Therefore, on a progress status report, total progress of the project may be shown as 40.303% with a staleness of 1.464 days. The staleness information provides additional insight to the project manager. For example, with a staleness value of 1.464 days, the project manager may feel fairly comfortable with the calculated total progress of the project. However, if the staleness value were to exceed five (5) days, the project manager may not trust that the calculated total progress of the project is representative of reality.

As mentioned previously herein, the status staleness values for multiple projects may be rolled up to an organization level. Just as the status staleness value is important in the decision making process of the project manager, status staleness at a summary level may be important to a higher level manager in making higher management decisions.

As an example, assume that higher management is interested in tracking the statuses of “risk of project failure” and “labor resource usage” over multiple projects. In one embodiment, risk of project failure is entered in the system 100 directly by a project manager. Labor resource usage is calculated as follows:

Labor Resource Usage=Labor Resource Capacity Required/Labor Resource Capacity Allocated.

Continuing with the example, assume the following organizational project hierarchy:

| | |
|---|---|
| 1. | Organization Root (R) |

| | |
|---|---|
| a. | North Zone Projects (N) |

| | |
|---|---|
| i. | Project Adam (A) |

| | |
|---|---|
| 1. | Failure Risk (FR) = 3, Staleness = 7 days, |
| | Project Size = $1.1 Million |
| 2. | Labor Resource Usage (LRU) = 0.73, |
| | Staleness = 3 days, Labor Resource Allocated |
| | Capacity = 86 persons |

| | |
|---|---|
| ii. | Project Borris (B) |

| | |
|---|---|
| 1. | Failure Risk (FR) = 5, Staleness = 3 days, |
| | Project Size = $0.2 Million |
| 2. | Labor Resource Usage (LRU) = 0.84, |
| | Staleness = 5 days, Labor Resource Allocated |
| | Capacity = 31 persons |

| | |
|---|---|
| b. | South Zone Projects (S) |

| | |
|---|---|
| i. | Project Connor (C) |

| | |
|---|---|
| 1. | Failure Risk (FR) = (Not Available) |
| 2. | Labor Resource Usage (LRU) = 0.37, |
| | Staleness = 15 days, Labor Resource Allocated |
| | Capacity = 44 persons |

| | |
|---|---|
| ii. | Project Delta (D) |

| | |
|---|---|
| 1. | Failure Risk (FR) = 1, Staleness = 5 days, |
| | Project Size = $220 Million |
| 2. | Labor Resource Usage (LRU) = 0.9, |
| | Staleness = 2 days, Labor Resource Allocated |
| | Capacity = 233 persons |

| | |
|---|---|
| iii. | Project Evergreen (E) |

| | |
|---|---|
| 1. | Failure Risk (FR) = 7, Staleness = 10 days, |
| | Project Size = $54 Million |
| 2. | Labor Resource Usage (LRU) = (Not |
| | Available) |

In one embodiment, the weight-based roll-up approach for staleness roll-up is followed through the project hierarchy, similar to the process described herein for staleness roll-up from the task level to the project level. The status staleness value for a project hierarchy node j is determined as follows:

$${ψ}_{j , status} = \frac{{\sum }_{i = 1}^{n} {ω}_{i , status} \times {ψ}_{i , status}}{{\sum }_{i = 1}^{n} {ω}_{i , status}} ,$$

where ω_{i,status} is the status-specific size of the project i, and ψ_{i,status} is the staleness of the same status for project I. When status is not available for any project i, ω_{i,status} is taken as 0. If for a project node j, the term Σᵢ₌₁ⁿ ω_{i,status} turns out to be 0, then ill ψ_{j,status} is also assumed to be 0 (to avoid dividing by zero).

For the example described immediately above herein, the rolled up status staleness values at the various hierarchical levels are calculated as follows:

$${ψ}_{N , FR} = \frac{{\sum }_{i = 1}^{n} {ω}_{i , FR} \times {ψ}_{i , FR}}{{\sum }_{i = 1}^{n} {ω}_{i , FR}} = \frac{{ω}_{A , FR} \times {ψ}_{A , FR} + {ω}_{B , FR} \times {ψ}_{B , FR}}{{ω}_{A , FR} + {ω}_{B , FR}} = \frac{1.1 \times 7 + 0.2 \times 3}{1.1 + 0.2} = \frac{8.3}{1.3} = 6.385$$

$${ψ}_{N , LRU} = \frac{{\sum }_{i = 1}^{n} {ω}_{i , LRU} \times {ψ}_{i , LRU}}{{\sum }_{i = 1}^{n} {ω}_{i , LRU}} = \frac{{ω}_{A , LRU} \times {ψ}_{B , LRU} + {ω}_{B , LRU} \times {ψ}_{B , LRU}}{{ω}_{A , LRU} + {ω}_{B , LRU}} = \frac{86 \times 3 + 31 \times 5}{86 + 31} = \frac{413}{117} = 3.530$$

$${ψ}_{S , FR} = \frac{{\sum }_{i = 1}^{n} {ω}_{i , FR} \times {ψ}_{i , FR}}{{\sum }_{i = 1}^{n} {ω}_{i , FR}} = \frac{{ω}_{C , FR} \times {ψ}_{C , FR} + {ω}_{D , FR} \times {ψ}_{D , FR} + {ω}_{E , FR} \times {ψ}_{E , FR}}{{ω}_{C , FR} + {ω}_{D , FR} + {ω}_{E , FR}} = \frac{0 \times ( ? )+220×5+54×10}{0 + 220 + 54} = \frac{1640}{274} = 5.985$$

$${ψ}_{S , LRU} = \frac{{\sum }_{i = 1}^{n} {ω}_{i , LRU} \times {ψ}_{i , LRU}}{{\sum }_{i = 1}^{n} {ω}_{i , LRU}} = \frac{{ω}_{C , LRU} \times {ψ}_{C , LRU} + {ω}_{D , LRU} \times {ψ}_{D , LRU} + {ω}_{E , LRU} \times {ψ}_{E , LRU}}{{ω}_{C , LRU} + {ω}_{D , LRU} + {ω}_{E , LRU}} = \frac{44 \times 15 + 233 \times 2 + 0 \times ( ? )}{44 + 233 + 0} = \frac{1126}{277} = 4.065$$

$${ψ}_{R , FR} = \frac{{\sum }_{i = 1}^{n} {ω}_{i , FR} \times {ψ}_{i , FR}}{{\sum }_{i = 1}^{n} {ω}_{i , FR}} = \frac{{ω}_{N , FR} \times {ψ}_{N , FR} + {ω}_{S , FR} \times {ψ}_{S , FR}}{{ω}_{N , FR} + {ω}_{S , FR}} = \frac{1.3 \times 6.385 + 274 \times 5.985}{1.3 + 274} = \frac{1648.191}{275.3} = 5.987$$

$${ψ}_{R , LRU} = \frac{{\sum }_{i = 1}^{n} {ω}_{i , LRU} \times {ψ}_{i , LRU}}{{\sum }_{i = 1}^{n} {ω}_{i , LRU}} = \frac{{ω}_{N , LRU} \times {ψ}_{N , LRU} + {ω}_{S , LRU} \times {ψ}_{S , LRU}}{{ω}_{N , LRU} + {ω}_{S , LRU}} = \frac{117 \times 3.530 + 277 \times 4.065}{117 + 277} = \frac{1539.015}{394} = 3.906$$

As seen above, the weights are summed at every node in the hierarchy. In this manner, application of weight-based roll-up for achieving staleness roll-up through project hierarchy with subtle adjustments is provided. “Project failure risk” and “labor resource usage” are just example status types used in the above example herein. The hierarchical roll-up process may be used with other status types as well, in accordance with other embodiments. In accordance with another embodiment, an application may employ a different algorithm for organization level roll-up. For example, different equations and/or different coefficients may be configured without departing from the scope of the present application.

In accordance with one embodiment, the visual user interface logic 130 is configured to allow a user to drill down (via a graphical user interface) from the root organization level, to the project level, to the reportable component level for a particular status type. In this manner, a higher level manager may investigate the underlying cause of a problem associated with a status or status staleness.

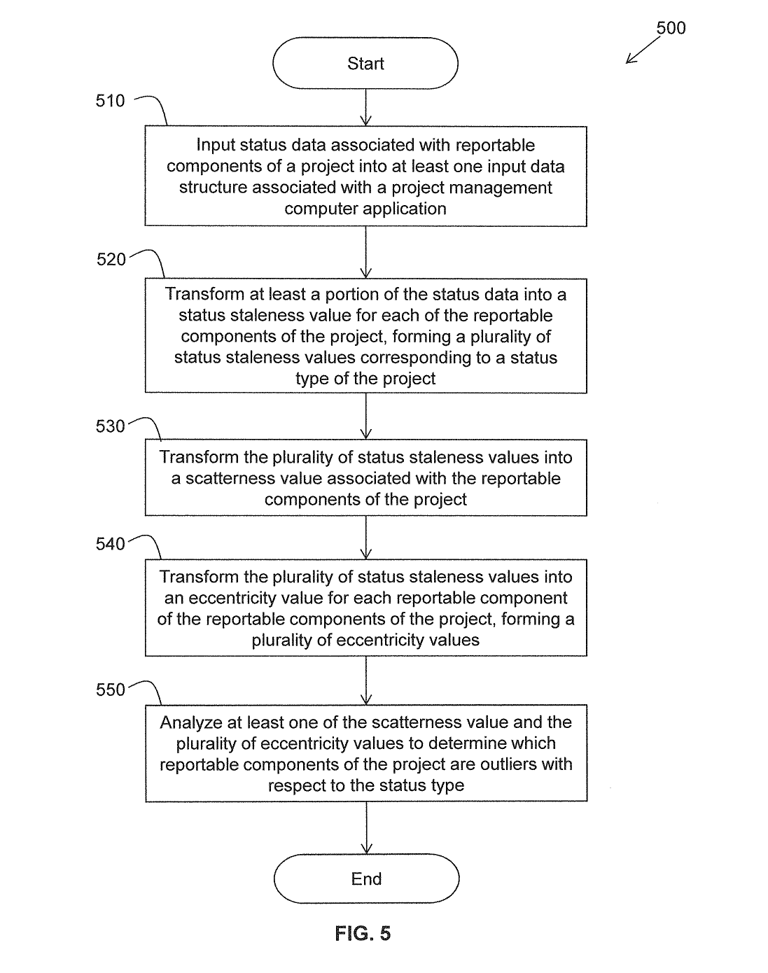

FIG. 5 illustrates one embodiment of a method 500 performed by the project staleness tool 110 of the computer system 100 of FIG. 1, for determining outliers of a project for a status type. Method 500 is implemented to be performed by the project staleness tool 110 of FIG. 1, or by a computing device configured with an algorithm of the method 500.

Method 500 will be described from the perspective that a project has many components including tasks and resources. Each component of a project may be reportable in the sense that a status of one or more status types of a component may be reported (e.g., to the system 100). By reviewing the statuses and associated staleness of the components of a project, a user (e.g., a project manager) may gain keen insight into how well the project is doing.

Upon initiating method 500, at block 510, status data associated with reportable components of a project is input into at least one input data structure associated with a project management computer application (e.g., project staleness tool 110 of FIG. 1). In accordance with one embodiment, the status staleness logic 115 of the project staleness tool 110 is configured to read the status data. For example, the status data may correspond to the progress of tasks of the project. The assumption is that status data is normally updated on a regular basis. However, the reporting of status data may be delayed in certain circumstances for certain reportable components. As such, the latest available status data may or may not reflect the true status.

At block 520, at least a portion of the status data is transformed into a status staleness value for each reportable component of the project, forming a plurality of status staleness values. The plurality of status staleness values correspond to a status type of the project (e.g., project progress). In accordance with one embodiment, the status staleness logic 115 transforms the status data into status staleness values. For example, a status staleness value for a reportable component may correspond to a number of days since status data was last reported or updated for the reportable component.

At block 530, the plurality of status staleness values is transformed into a scatterness value associated with the reportable components of the project. Also, at block 540, the plurality of status staleness values is transformed into an eccentricity value for each reportable component of the project, forming a plurality of eccentricity values. In accordance with one embodiment, the staleness correlation logic 125 is configured to transform the status staleness values into a scatterness value and the plurality of eccentricity values.

At block 550, the scatterness value and the eccentricity values are analyzed to determine which, if any, reportable components of the project are outliers with respect to the status type. In one embodiment, an outlier corresponds to a status staleness value, within a group of status staleness values of a group of reportable components, which is significantly different from the other status staleness values in the group.

The scatterness value λ indicates how widely the status staleness values for a group of reportable components are scattered. In one embodiment, the scatterness value λ is calculated as follows:

$$λ = \frac{σ}{μ} ,$$

where σ and μ are the standard deviation and mean, respectively, of the status staleness values for a group of reportable components.

The eccentricity value εᵢ, for each reportable component (i for the i^{th} component having an i^{th} status staleness value) of the project, indicates how far the i^{th} status staleness value is with respect to the others. In one embodiment, each eccentricity value εᵢ is calculated as follows:

$${∈}_{i} = \frac{{ψ}_{i} - μ}{σ} ,$$

where ψᵢ is the i^{th} status staleness value corresponding to the i^{th} reportable component.

The mean, μ, may be calculated as follows:

$$μ = \frac{{\sum }_{i = 1}^{n} {ψ}_{i}}{n} ,$$

where n is the number of status staleness values and the number of reportable components in the group.

The standard deviation, σ, may be calculated as follows:

$$σ = \sqrt{\frac{{\sum }_{i = 1}^{n} {( μ - {ψ}_{i} )}^{2}}{n}} .$$

Again, the scatterness value, λ, may be calculated as follows:

$$λ = \frac{σ}{μ} .$$

In accordance with one embodiment, when the scatterness value λ is determined to be greater than or equal to 0.5 (λ≧0.5), then the existence of outliers is inferred. When the scatterness value λ is determined to be less than 0.5, then it is presumed that there are no outliers in the group.

Again, the eccentricity value, εᵢ, for each reportable component in the group may be calculated as follows:

$${∈}_{i} = \frac{{ψ}_{i} - μ}{σ} .$$

When σ=0, meaning that all status staleness values in the group are the same, εᵢ is defined to be 0. In one embodiment, for any reportable component having an eccentricity value greater than or equal to 1.0 (εᵢ≧1.0), the associated status staleness value is considered to be an outlier. It is noted that a reportable component having an eccentricity value that is less than 0 is considered to be very fresh (not stale).

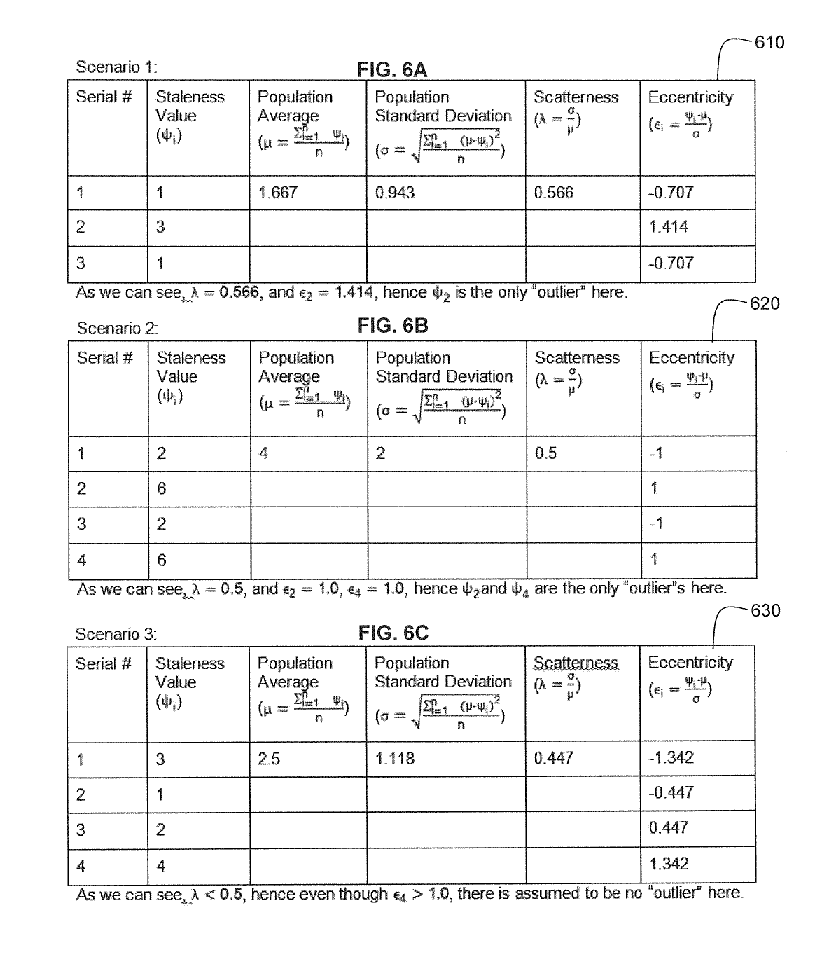

FIGS. 6A-6C illustrate example embodiments of tables 610, 620, and 630 showing status staleness correlation for three example scenarios using the method 500 of FIG. 5. Referring to table 610 of FIG. 6A, there are three (3) staleness values in the group corresponding to three (3) reportable components (serial #'s 1, 2, and 3) for a particular status type. It can be seen that λ=0.566 and ε₂=1.414. Therefore, the status staleness value ψ₂, corresponding to the second reportable component (serial #2), is identified as being an outlier.

Referring to table 620 of FIG. 6B, there are four (4) staleness values in the group corresponding to four (4) reportable components (serial #'s 1, 2, 3, and 4) for a particular status type. It can be seen that λ=0.5, ε₂=1.0, and ε₄=1.0. Therefore, the status staleness values ψ₂ and ψ₄, corresponding to the second and fourth reportable components (serial #2 and 4), are identified as being outliers. Referring to table 630 of FIG. 6C, there are four (4) staleness values in the group corresponding to four (4) reportable components (serial #'s 1, 2, 3, and 4) for a particular status type. It can be seen that λ<0.5. Therefore, even though ε₄>1.0, there is assumed to be no outliers in this group.

In this manner, identification of an outlier is essentially identifying a reportable component of a group that is extra stale with respect to the other reportable components of the group for a particular status type. It is noted that other formulations of scatterness and eccentricity may be determined, in accordance with other embodiments, without departing from the scope of the present application. Furthermore, in accordance with one embodiment, data identifying which reportable components have been determined to be outliers may be output for display to at least one output data structure associated with the project management computer application.

Systems, methods, and other embodiments for determining the staleness of activities of a project plan as well as of the project plan itself, associated with a computer application, have been described herein. In one embodiment, a project staleness tool is configured to generate status staleness values for reportable components of a project. The status staleness values for the reportable components may be rolled up into a status staleness value for the entire project. Furthermore, reportable components may be determined to be outliers with respect to status staleness and may be accounted for accordingly. This provides more insight to a project manager with respect to individual components of a project and with respect to the entire project for a particular status type.

Computing Device Embodiment

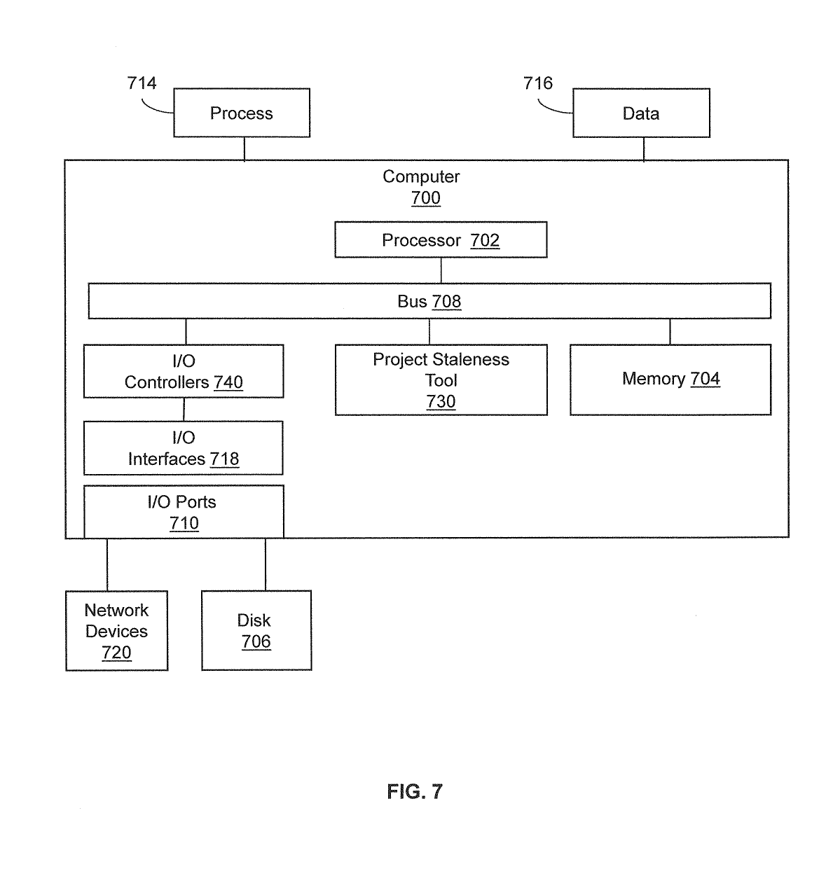

FIG. 7 illustrates an example computing device that is configured and/or programmed with one or more of the example systems and methods described herein, and/or equivalents. FIG. 7 illustrates one example embodiment of a computing device upon which an embodiment of a project staleness tool may be implemented. The example computing device may be a computer 700 that includes a processor 702, a memory 704, and input/output ports 710 operably connected by a bus 708. In one example, the computer 700 may include project staleness tool 730 configured to facilitate the determination of how stale or dated project information is, similar to project staleness tool 110 shown in FIG. 1. In different examples, the tool 730 may be implemented in hardware, a non-transitory computer-readable medium with stored instructions, firmware, and/or combinations thereof. While the tool 730 is illustrated as a hardware component attached to the bus 708, it is to be appreciated that in other embodiments, the tool 730 could be implemented in the processor 702, stored in memory 704, or stored in disk 706.

In one embodiment, tool 730 or the computer 700 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the management of components (e.g., tasks and resources) of a project plan. The means may also be implemented as stored computer executable instructions that are presented to computer 700 as data 716 that are temporarily stored in memory 704 and then executed by processor 702.

Tool 730 may also provide means (e.g., hardware, non-transitory computer-readable medium that stores executable instructions, firmware) for facilitating the determination of how stale or dated project information may be.

Generally describing an example configuration of the computer 700, the processor 702 may be a variety of various processors including dual microprocessor and other multi-processor architectures. A memory 704 may include volatile memory and/or non-volatile memory. Non-volatile memory may include, for example, ROM, PROM, and so on. Volatile memory may include, for example, RAM, SRAM, DRAM, and so on.

A storage disk 706 may be operably connected to the computer 700 via, for example, an input/output interface (e.g., card, device) 718 and an input/output port 710. The disk 706 may be, for example, a magnetic disk drive, a solid state disk drive, a floppy disk drive, a tape drive, a Zip drive, a flash memory card, a memory stick, and so on. Furthermore, the disk 706 may be a CD-ROM drive, a CD-R drive, a CD-RW drive, a DVD ROM, and so on. The memory 704 can store a process 714 and/or a data 716, for example. The disk 706 and/or the memory 704 can store an operating system that controls and allocates resources of the computer 700.

The computer 700 may interact with input/output devices via the i/o interfaces 718 and the input/output ports 710. Input/output devices may be, for example, a keyboard, a microphone, a pointing and selection device, cameras, video cards, displays, the disk 706, the network devices 720, and so on. The input/output ports 710 may include, for example, serial ports, parallel ports, and USB ports.

The computer 700 can operate in a network environment and thus may be connected to the network devices 720 via the i/o interfaces 718, and/or the i/o ports 710. Through the network devices 720, the computer 700 may interact with a network. Through the network, the computer 700 may be logically connected to remote computers. Networks with which the computer 700 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method, associated with a project management computer application configured to execute on a computing device, comprising:
inputting status data associated with reportable components of a project into at least one input data structure associated with the project management computer application;
transforming at least a portion of the status data into a status staleness value for each of the reportable components of the project, forming a plurality of status staleness values corresponding to a status type of the project;
transforming the plurality of status staleness values into a project staleness value for the project corresponding to the status type; and
outputting the project staleness value for the project, for display, to at least one output data structure associated with the project management computer application.

2. The method of claim 1, further comprising:
transforming at least a different portion of the status data into a status staleness value for each of the reportable components of the project, forming a different plurality of status staleness values corresponding to a different status type of the project; and
transforming the different plurality of status staleness values into a different project staleness value for the project corresponding to the different status type.

3. The method of claim 1, wherein the status type of the project includes one of project progress, labor availability, raw material availability, equipment availability, failure risk, labor resource usage, resource productivity, public perception of brand value, public perception of a product line, or public perception of the reliability of a product.

4. The method of claim 1, wherein the reportable components of the project include at least one of tasks of the project, resources used in the project, groups of related tasks of the project, and groups of related resources used in the project.

5. The method of claim 1, wherein transforming the plurality of status staleness values includes generating a weighted average of the plurality of status staleness values as the project staleness value.

6. The method of claim 1, further comprising outputting, for display to at least one output data structure associated with the project management computer application, an indication of whether the project staleness value is within an acceptable range for the status type.

7. The method of claim 1, further comprising determining status staleness outliers of the reportable components of the project based on at least the plurality of status staleness values.

8. The method of claim 7, wherein the determining includes:
transforming the plurality of status staleness values to a scatterness value for the reportable components of the project; and
transforming the plurality of status staleness values to an eccentricity value for each reportable component of the reportable components of the project.

9. The method of claim 1, further comprising generating an organization status staleness value corresponding to the status type by rolling up the project staleness value for the project with at least one other project staleness value for at least one other project corresponding to the status type, where the project and the at least one other project are associated with a same organization.

10. A computing system, comprising:
a display screen configured to display and facilitate user interaction with at least a graphical user interface associated with a project management computer application;
visual user interface logic configured to generate the graphical user interface associated with the project management computer application;
status staleness logic configured to generate a status staleness value for each reportable component of a plurality of reportable components of a project, based on at least a portion of status data associated with the plurality of reportable components, forming a plurality of status staleness values corresponding to a status type of the project;
staleness roll-up logic configured to generate a project staleness value for the project, corresponding to the status type, based on at least the plurality of status staleness values; and
staleness correlation logic configured to determine status staleness outliers of the reportable components of the project based on at least the plurality of status staleness values.

11. The computing system of claim 10, wherein the staleness roll-up logic is configured to generate the project staleness value for the project by generating a weighted average of the plurality of status staleness values.

12. The computing system of claim 10, wherein the staleness correlation logic is configured to determine status staleness outliers by:
generating a scatterness value for the reportable components of the project based on the plurality of status staleness values; and
generating an eccentricity value for each reportable component of the reportable components of the project based on the plurality of status staleness values.

13. The computing system of claim 10, wherein the staleness roll-up logic is configured to generate an organization staleness value for an organization, corresponding to the status type, by rolling up the project staleness value for the project with at least one other project staleness value for at least one other project corresponding to the status type, where the project and the at least one other project are associated with the organization.

14. The computing system of claim 13, wherein the visual user interface logic is configured to operably interact with the staleness roll-up logic to allow a user to drill down from the organization staleness value for the organization to the status staleness value of a reportable component of the plurality of reportable components for the project.

15. The computing system of claim 10, wherein the visual user interface logic is configured to facilitate reading of the status data into at least one input data structure associated with the project management computer application.

16. The computing system of claim 10, further comprising a database device configured to store data structures associated with the project management computer application.

17. A non-transitory computer-readable medium storing computer-executable instructions that are part of an algorithm that, when executed by a computer, cause the computer to perform a method, wherein the instructions comprise instructions configured for:
inputting status data associated with reportable components of a project into at least one input data structure associated with a project management computer application;
transforming at least a portion of the status data into a status staleness value for each of the reportable components of the project, forming a plurality of status staleness values corresponding to a status type of the project;
transforming the plurality of status staleness values into a scatterness value associated with the reportable components of the project;
transforming the plurality of status staleness values into an eccentricity value for each reportable component of the reportable components of the project, forming a plurality of eccentricity values; and
analyzing at least one of the scatterness value and the plurality of eccentricity values to determine which reportable components of the project are outliers with respect to the status type.

18. The non-transitory computer-readable medium of claim 17, wherein the instructions for transforming the plurality of status staleness values to a scatterness value include instructions configured for generating a mean value and a standard deviation value of the plurality of status staleness values.

19. The non-transitory computer-readable medium of claim 17, wherein the instructions for transforming the plurality of status staleness values to an eccentricity value for each reportable component of the reportable components of the project include instructions configured for generating a mean value and a standard deviation value of the plurality of status staleness values.

20. The non-transitory computer-readable medium of claim 17, wherein the instructions further comprise instructions configured for outputting, for display, data identifying the reportable components of the project determined to be outliers to at least one output data structure associated with the project management computer application.
